(19) United States
(12) Patent Application Publication
(10) Pub. No.: US 2013/0021797 A1
(43) Pub. Date: Jan. 24, 2013

(54) ILLUMINATION APPARATUS AND PLANT CULTIVATION APPARATUS

(71) Applicant: Tomoki Kubo, Osaka-shi (JP)

(72) Inventor: Tomoki Kubo, Osaka-shi (JP)

(73) Assignee: SHARP KABUSHIKI KAISHA, Osaka-shi, Osaka (JP)

(21) Appl. No.: 13/637,906

(22) PCT Filed: Nov. 29, 2010
(86) PCT No.: PCT/JP2010/071276

§ 371 Date: Sep. 27, 2012

(30) Foreign Application Priority Data
Mar. 31, 2010 (JP) 2010-083350

(51) Int. Cl. F21V 11/00

(52) U.S. Cl. 362/235

(57) ABSTRACT

An illumination apparatus (12) of the present invention is an illumination apparatus for irradiating a plant with light. The illumination apparatus (12) includes a light-emitting diodes (23) serving as light sources; an LED substrate (22) on which the light-emitting diodes (23) are provided; a lens (25) (an optical member) provided between the LED substrate (22) and the plant to be irradiated, the lens (25) changing the paths of light emitted from the light-emitting diodes (23); and a lens holding plate (24) (an optical member) to hold the lens (25). The lens (25) is removably attached to the apparatus. With this configuration, it is possible to provide an illumination apparatus for cultivating plants, which illumination apparatus has been improved from the viewpoint of control of heat generated by an LED and control of light distribution of the LED.

### TECHNICAL FIELD

The present invention relates to an illumination apparatus for cultivating plants and a plant cultivation apparatus including the illumination apparatus.

### BACKGROUND ART

Illumination apparatuses using light-emitting diodes (LED) as light sources have been used in various fields recently. For example, there has been proposed the use of LED illumination apparatuses as artificial light sources for plant factories or plant cultivation apparatuses for cultivating plants such as vegetables indoors.

LEDs are very advantageous as light sources for plant cultivation, for the following reasons. The LEDs are efficient as light sources for plants because only light having wavelengths necessary for plants can be selected. In addition, the LEDs do not contain any infrared rays or heat rays, which are contained in a large amount in conventional light sources such as incandescent lamps, fluorescent lamps, metal halide lamps, and high-pressure sodium lamps. That is, conventional light sources are less advantageous in light use efficiency, because, according to the conventional light sources, it is necessary to avoid direct illumination of cultivated plants at a short distance (that is, a heat ray elimination device which is expensive and takes up a lot of space is necessary) in order to prevent damages such as scorch caused by heat rays. On the other hand, using an LED as a light source enables emission of rays that contain no infrared rays or heat rays, and makes it possible to convert much of supplied electric power to energy for light emission. This makes it possible to irradiate plants from a very short distance, and possible to reduce electric power consumption. Accordingly, a highly efficient illumination apparatus for cultivating plants can be achieved. For example, Patent Literatures 1 to 3 each propose a technique of utilizing, for cultivating plants, an illumination apparatus using an LED as a light source.

Note however that, although an LED light source does not generate heat rays unlike conventional light sources, part of electric power supplied to the LED light source is not converted into light and thus the temperature of LED element itself increases (that is, the LED element generates heat). Due to such heat generated by the LED, the temperature of the surface of an LED package may reach approximately 40° C. to 80° C. This is not preferable for cultivating plants. Further, an increase in temperature of the LED element is not preferable, because it can cause performance degradation of the LED element itself. To address this, it is desirable to take some measure to allow the LED element and an LED substrate to dissipate heat.

For example, Patent Literature 1 proposes a plant cultivation apparatus including a cooling device for cooling an LED, which cooling device is provided on an LED light source in the form of a panel. This plant cultivation apparatus is capable of reducing electric power consumption by using an LED as a light source, and prevents an increase in temperature of the LED itself by providing the cooling device.

### CITATION LIST

### Patent Literatures

Patent Literature 1
Japanese Patent Application Publication, Tokukaihei, No. 9-98665 A (Publication Date: Apr. 15, 1997)

Patent Literature 2
Japanese Patent Application Publication, Tokukai, No. 2005-185823 A (Publication Date: Jul. 14, 2005)

Patent Literature 3
Japanese Patent Application Publication, Tokukai, No. 2008-142030 A (Publication Date: Jun. 26, 2008)

### SUMMARY OF INVENTION

### Technical Problem

However, according to the plant cultivation apparatus described in Patent Literature 1, the LED is cooled with use of a cooling medium on a surface opposite the surface where the LED is provided. That is, the plant cultivation apparatus described in Patent Literature 1 is not configured to reduce, on the side on which light is emitted from the LED, the effect of heat generated by the LED between the LED and a plant.

The plant cultivation apparatus described in Patent Literature 1 further has the following problem. When a temperature difference arises between the vicinity of a substrate on which the LED is provided and a place where a plant is placed as the LED generates heat, condensation may form on the LED. Such condensation is not desirable, because it may damage the LED and shorten the lifetime of the LED. However, in the plant cultivation apparatus described in Patent Literature 1, no measures are taken to address condensation.

Further, conventional illumination apparatuses using LEDs as light sources are not configured to be able to control the intensity distribution of light emitted from the LEDs (this is called “light distribution” of LED) in each direction.

The present invention has been made in view of the above problems, and an object of the present invention is to provide an illumination apparatus for cultivating plants, which illumination apparatus has been improved from the viewpoint of control of heat generated by an LED and control of light distribution of the LED.

### Solution to Problem

In order to attain the above object, an illumination apparatus in accordance with the present invention is an illumination apparatus for irradiating a plant with light, including: light-emitting diodes serving as light sources; a substrate on which the light-emitting diodes are arranged; and an optical member provided between the substrate and the plant to be irradiated, the optical member being for changing the paths of light emitted from the light-emitting diodes, the optical member being removably attached to the illumination apparatus.

According to the illumination apparatus of the present invention, the optical member capable of changing the path of light from a light-emitting diode is removably attached to the apparatus. As used herein, the phrase “change the path of light” means making a change to light having been emitted from the light source so that the area to be irradiated with the light and/or the direction in which the light travels are changed. Further, the expression “change the path of light from the light-emitting diode” can be rephrased as “control the light distribution of the light-emitting diode”.

According to the above configuration, it is possible, by properly using optical members having different characteristics depending on the purposes, to change the area to be irradiated with light emitted from the light-emitting diode and the direction in which the light travels. Accordingly, the illumination apparatus of the present invention is capable of efficiently irradiating a plant with light depending on the type and/or growth state of the plant to be irradiated.

Further, according to a plant cultivation apparatus of the present invention, the optical member is provided between the plant and the substrate on which the light-emitting diodes are provided. This makes it possible to achieve a structure in which heat generated from the light-emitting diodes is difficult to reach the plant. Furthermore, in a case where the optical member is made of a high thermal conductive material, the optical member absorbs the heat generated from the light-emitting diodes and from the surface of the substrate, and thus the heat can be efficiently dissipated. Accordingly, it is possible to cool the light-emitting diodes more effectively than a conventional configuration in which the light-emitting diodes are cooled only through the cooling plate provided on the back surface of the substrate.

Moreover, according to the above configuration, since the optical member is provided between the plant and the substrate on which the light-emitting diodes are provided, the substrate decreases in the area where it is exposed to air. Therefore, it is possible to make the substrate less cooled by air and make the light-emitting diodes less prone to condensation even if condensation forms because of a temperature difference between the space where the plant is placed and the light-emitting diodes. Accordingly, the light-emitting diodes are not damaged by condensation, so that the reliability of the light-emitting diodes can be improved and the lifetime of the light-emitting diodes can be increased.

A plant cultivation apparatus in accordance with the present invention includes any one of the above illumination apparatuses.

Accordingly, the plant cultivation apparatus of the present invention is capable of changing, depending on the purposes, the area to be irradiated with light emitted from a light-emitting diode and the direction in which the light travels. Further, according to the plant cultivation apparatus of the present invention, since the optical member is provided between the plant and the substrate on which with the light-emitting diodes are provided, it is possible to achieve a structure in which heat generated from the light-emitting diodes is difficult to reach the plant.

Moreover, according to the plant cultivation apparatus of the present invention, since the optical member is provided between the plant and the substrate on which the light-emitting diodes are provided, it is possible to make the light-emitting diodes less prone to condensation even if condensation forms because of a temperature difference between the space where the plant is placed and the light-emitting diodes. As such, the light-emitting diodes are not damaged by condensation, so that the reliability of the light-emitting diodes can be improved and the lifetime of the light-emitting diodes can be increased.

### Advantageous Effects of Invention

According to an illumination apparatus and a plant cultivation apparatus of the present invention, it is possible to easily control light distribution of a light-emitting diode by changing optical members depending on the purposes. Further, since the optical member is provided between the light-emitting diode and a plant, it is possible to realize a structure in which the plant is less affected by heat generated by the light-emitting diode and a structure in which condensation is difficult to form on the light-emitting diode.

### BRIEF DESCRIPTION OF DRAWINGS

FIG. 1 is a perspective view illustrating a configuration of an illumination apparatus in accordance with an embodiment of the present invention.

FIG. 2 is a perspective view illustrating a configuration of a plant cultivation apparatus in accordance with an embodiment of the present invention.

FIG. 3 is a perspective view illustrating disassembled components of the illumination apparatus illustrated in FIG. 1.

FIG. 4 is an enlarged cross-sectional view illustrating part of the illumination apparatus illustrated in FIG. 1.

FIG. 5 is a view schematically illustrating a specific example of an LED substrate that constitutes the illumination apparatus illustrated in FIG. 1.

FIG. 6 is a further enlarged cross-sectional view illustrating part of the illumination apparatus illustrated in FIG. 4.

(a) to (d) of FIG. 7 are cross-sectional views each illustrating a specific example of a configuration of a lens included in an illumination apparatus in accordance with an embodiment of the present invention.

(a) to (c) of FIG. 8 are cross-sectional views each illustrating a specific example of a configuration of a lens included in a plant cultivation apparatus in accordance with an embodiment of the present invention.

FIG. 9, showing a configuration different from that illustrated in FIG. 6, is an enlarged cross-sectional view illustrating part of an illumination apparatus in accordance with an embodiment of the present invention.

FIG. 10 is a perspective view illustrating a configuration of an illumination apparatus in accordance with another embodiment of the present invention.

FIG. 11 is a perspective view illustrating disassembled components of the illumination apparatus illustrated in FIG. 10.

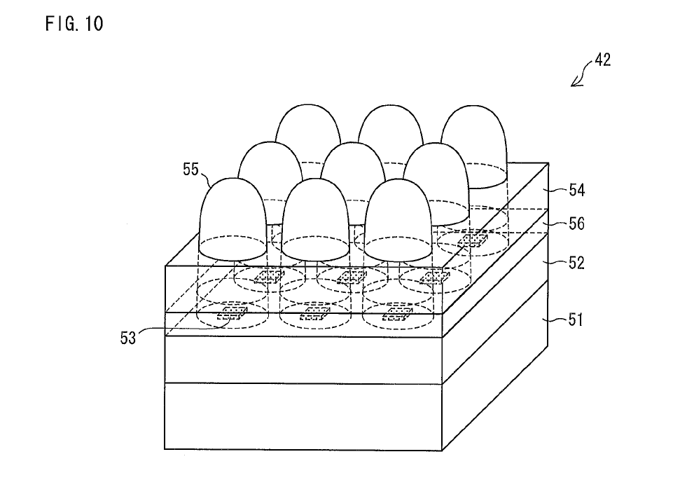

(a) of FIG. 12 is an enlarged cross-sectional view illustrating part of the illumination apparatus illustrated in FIG. 10. (b) of FIG. 12 is a plan view of a lens holding plate and a thermal conductive sheet, which are included in the illumination apparatus illustrated in FIG. 10. (c) of FIG. 12 is a further enlarged cross-sectional view of part of the illumination apparatus illustrated in (a) of FIG. 12.

### DESCRIPTION OF EMBODIMENTS

### Embodiment 1

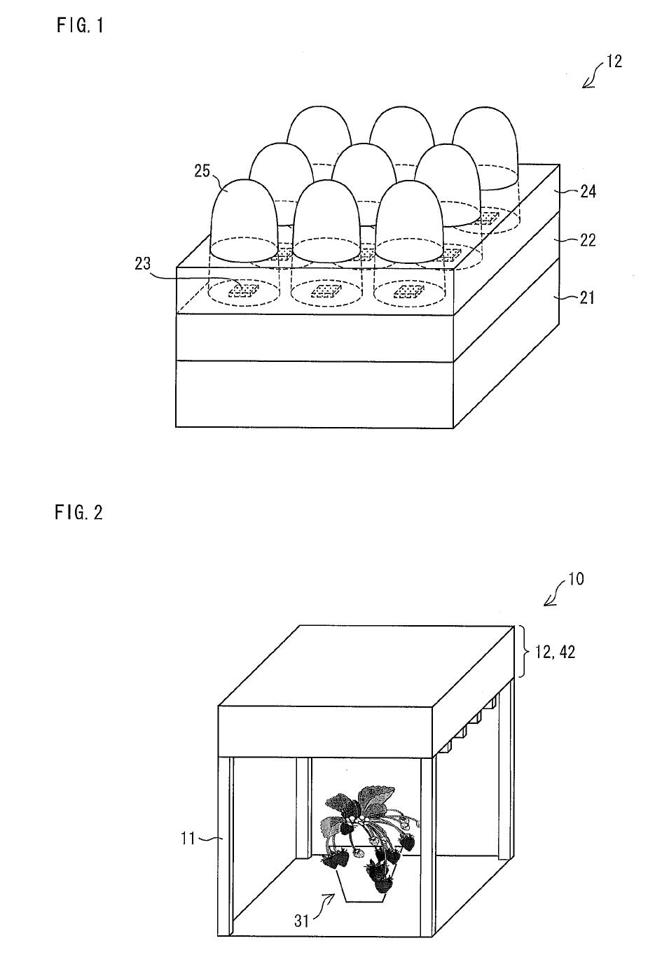

One embodiment of the present invention is described below with reference to FIG. 1 to FIG. 9. Note however that, unless otherwise specifically stated, the dimensions, materials, shapes, relative positions etc. of constituents described in the present embodiment do not imply any limitation on the scope of the present invention, and therefore are mere examples for descriptions.

(Schematic Configuration of Plant Cultivation Apparatus)

FIG. 2 illustrates the external appearance of a plant cultivation apparatus 10 in accordance with the present embodiment. As illustrated in FIG. 2, the plant cultivation apparatus 10 is constituted by a case 11 in the shape of a cube and an illumination apparatus 12 provided on the top face of the case 11. In the plant cultivation apparatus 10, a plant 31 is placed on the bottom face of the case 11, and is irradiated with light from the illumination apparatus 12 provided on the top face. The shape of the case 11 is not limited to a cube as illustrated in FIG. 2. Examples of other shapes include a shape constituted by a plurality of shelves, a columnar shelf, and a terraced shape. Further, the position of the illumination apparatus 12 is not necessarily limited to the top face, provided that the plant placed in the case 11 can be irradiated with light.

(Configuration of Illumination Apparatus)

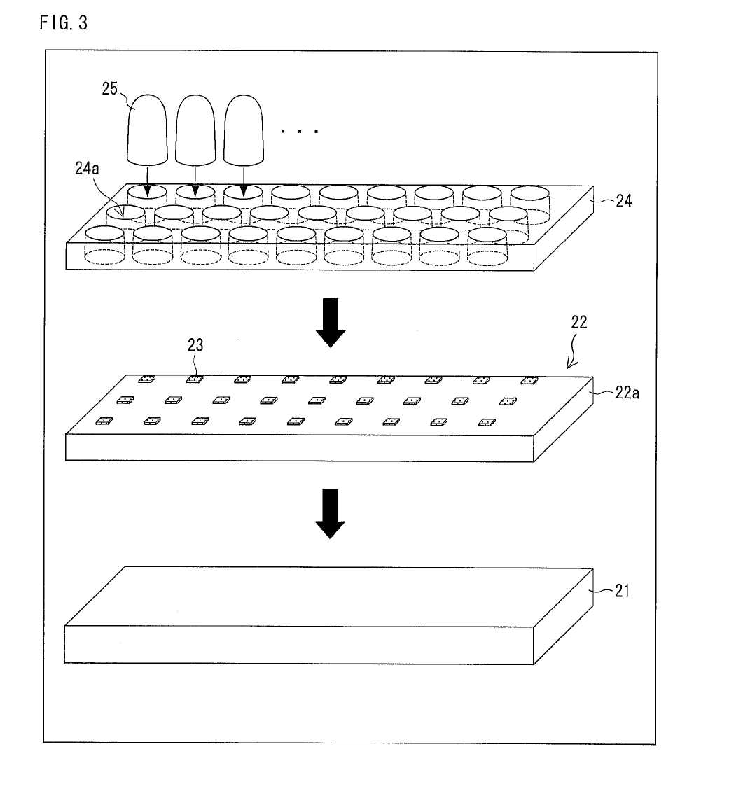

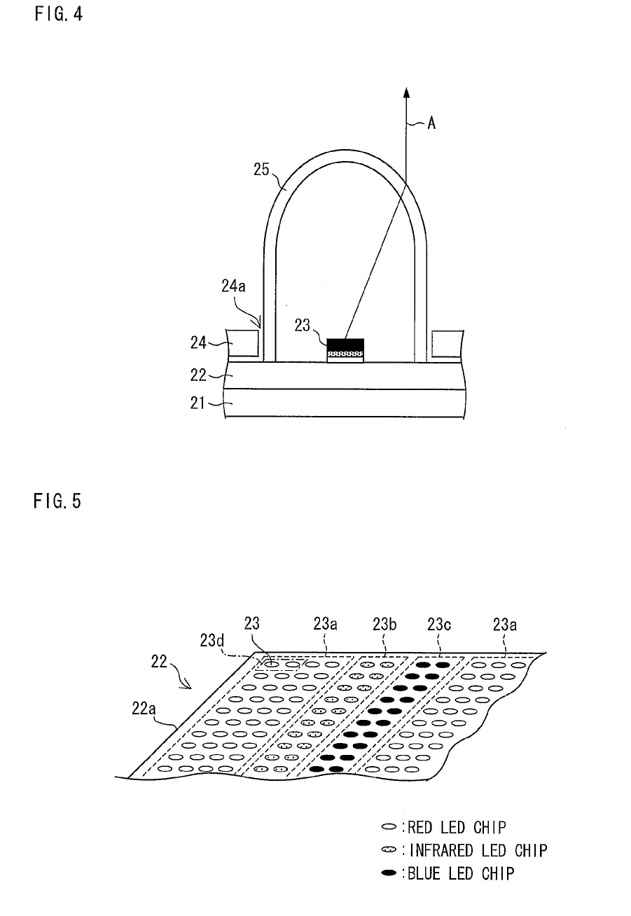

The following description discusses a specific configuration of the illumination apparatus 12 provided to the plant cultivation apparatus 10. FIG. 1 is a perspective view illustrating the illumination apparatus 12. In FIG. 1, the illumination apparatus 12 which is provided to the plant cultivation apparatus 10 is placed upside down. FIG. 3 illustrates disassembled components of the illumination apparatus 12. FIG. 4 is an enlarged view illustrating a lens of the illumination apparatus 12.

As illustrated in FIGS. 1 and 3, in the illumination apparatus 12, an LED substrate 22 (substrate) and a lens holding plate 24 (a holding plate, an optical member) are stacked in this order on a cooling plate 21.

The cooling plate 21 is provided on the backside of the LED substrate 22 (on the side opposite the side on which a plant is placed), and is capable of absorbing heat generated from an LED chip 23 (light-emitting diode) at a time of light irradiation. The cooling plate 21 can be configured similarly to a cooling plate for use in conventional illumination apparatuses for cultivating plants. Basically, the configuration of the cooling plate is not limited provided that heat from the LED travels to the cooling plate via the substrate and flows due to thermal conduction to be dissipated.

Specific examples of the cooling plate include aluminum plates and copper plates. Note that the cooling plate does not have to be a plate. A device such as an air-cooling device or a water-cooling device formed with use of a plate made of aluminum or copper can be used instead of the cooling plate.

The LED substrate 22 is constituted by a substrate 22a (for example, an insulating substrate) on which a plurality of LED chips 23 (LED packages) are arranged. The LED chips 23 can be configured similarly to LED chips for use in conventional illumination apparatuses for cultivating plants. That is, usually, general-purpose LED chips can be used as the LED chips 23. Note that some usual LED chips (LED packages) have lenses attached thereto. However, in the present invention, it is preferable to use a package without a lens because a lens is separately attached to the package (described later).

The LED chips can be LED chips that emit light of the same color or can be constituted by different kinds of LED chips that emit light of different wavelengths.

FIG. 5 illustrates an example of how to arrange the plurality of LED chips 23 on the LED substrate 22. On the substrate 22a illustrated in FIG. 5, three LED groups, i.e., a red LED group 23a of red LED chips, an infrared LED group 23b of infrared LED chips, and a blue LED group 23c of blue LED chips, are arranged in this order from left to right in FIG. 5. In the example shown in FIG. 5, two LEDs of the same kind constitute one unit 23d, and such units are repeatedly arranged vertically and horizontally.

The lens holding plate 24 has holes 24a which correspond to the LED chips 23 arranged on the LED substrate 22. With this configuration, the LED chips 23 are positioned in the respective holes 24a when the lens holding plate 24 is stacked on the LED substrate 22 (see FIG. 4). According to the present embodiment, the lens holding plate 24 is made of a metal having a high thermal conductivity and high reflectivity. More specifically, the lens holding plate 24 can be made of aluminum, copper and/or the like.

Further, a lens 25 (a light path changing part, an optical member) for controlling the path of light emitted from the LED is fitted into each of the holes 24a in the lens holding plate 24. The lens 25 is for controlling the direction in which the light emitted from the LED chips 23 travels and the area to be irradiated with the light (that is, light distribution of LEDs).

The light distribution of the LED can be controlled by changing as appropriate the shape of the lens 25 in view of Snell's law. Specifically, by changing the curvature of the curved surface of a protrusion of the lens 25 which has a convex shape, the path of light emitted from an LED chip 23 can be bent so that the path is perpendicular to a light emitting surface of the LED substrate 22 as indicated by the arrow A in FIG. 4.

The phrase “controlled by changing as appropriate the shape of the lens 25 in view of Snell's law” means for example the following. In a case of a convex lens, light that fulfills the condition of total reflection of light on a convex surface is emitted so as to be concentrated inside. On the other hand, in a case of a concave lens, light that fulfills the condition of total reflection of light on a concave surface is emitted in a spreading-out direction. It is possible to control the light distribution of LEDs by utilizing these characteristics of the lens.

Examples of a material for the lens 25 include transparent resins such as (meth)acrylic resin, COP (cycloolefin polymer), COC (cycloolefin copolymer), and polycarbonate. Specific examples of the (meth)acrylic resin include PMMA (methyl methacrylate resin). Specific examples of COP (cycloolefin polymer) include ZEONOR® (registered trademark, produced by ZEON CORPORATION).

A plant to be irradiated with light by the illumination apparatus 12 configured like above is placed on the lens holding plate 24 side of the LED substrate 22. That is, the lens holding plate 24 is provided on the light emitting surface side of the LED substrate 22, and the cooling plate 21 is provided on the side opposite the light emitting surface side.

As described above, the illumination apparatus 12 of the present embodiment is configured such that (i) the cooling plate 21 is provided on the back surface of the LED substrate 22 and, in addition, (ii) the lens holding plate 24 made of a high thermal conductive material is provided between the LED substrate 22 and the plant 31 to be irradiated with light. With this configuration, the lens holding plate 24 absorbs heat generated from the surface of the LED substrate 22 and the heat can be dissipated efficiently. This makes it possible to cool the LED chips more effectively than the configuration in which the LED chips are cooled only through the cooling plate 21.

Further, the illumination apparatus 12 of the present embodiment is configured such that (i) the lens 25 and the lens holding plate 24 are separately provided and (ii) the lens 25 is removably fitted in each of the holes 24a in the lens holding plate 24. This makes it possible to replace the lens with another lens that has a different shape depending on the purposes and to thereby control the direction in which light from the LED chips 23 travels and the area to be irradiated with the light. Further, like the present embodiment, different types of lenses 25 can be attached to respective LED chips 23. With this configuration, it is possible to independently control the light distribution of each of the LED chips 23.

Moreover, the illumination apparatus 12 of the present embodiment is configured such that the lens holding plate 24 and the lenses 25 are provided between the LED chips 23 and the plant 31. According to the present embodiment, since the LED chips 23 are covered with the lenses 25 and the lens holding plate 24 like above, the LED chips 23 are not exposed to a space where the plant 31 is placed. Therefore, even if condensation forms because of a temperature difference between the space where the plant 31 is placed and a region where the LED chips 23 are provided, the condensation is on the surfaces of the lenses 25 (on surfaces in contact with the space where the plant 31 is placed). That is, condensation does not form on the LED chips 23. Accordingly, the LED chips 23 are not damaged by condensation, and thus the reliability of the LED chips 23 can be improved and the lifetime of the LED chips 23 can be increased.

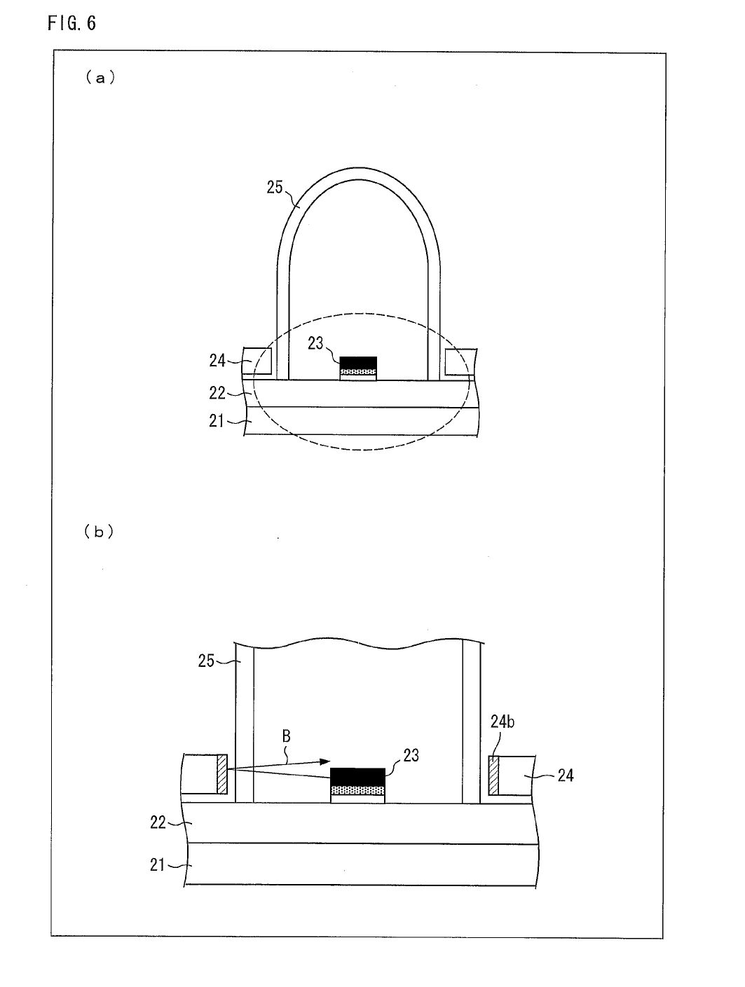

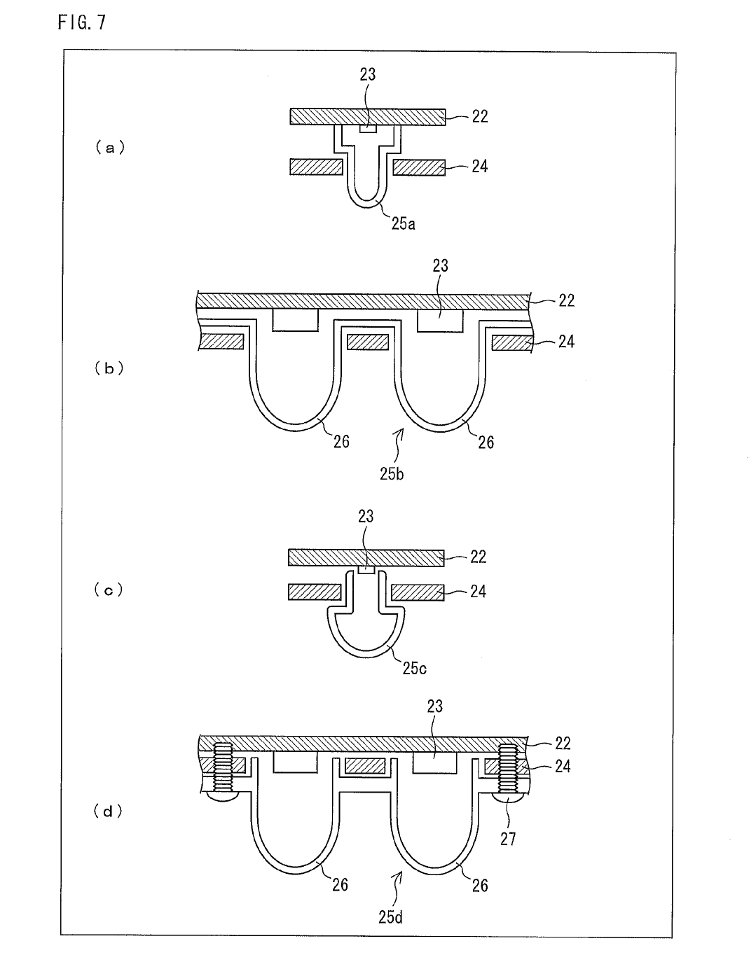

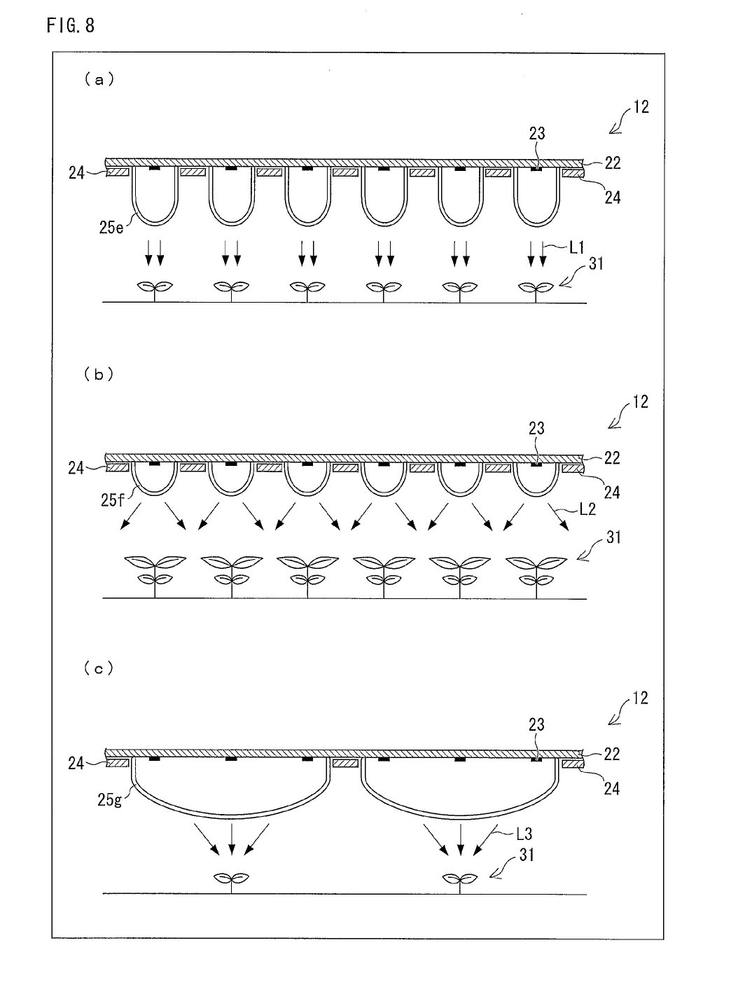

The following description discusses, with reference to FIG. 6, a configuration for more efficient irradiation of a plant with light from the LED chips. (a) of FIG. 6 is a cross-sectional view of a configuration of one of the lenses 25 of the illumination apparatus 12. (b) of FIG. 6 is a more enlarged view showing a part encircled by a dotted line of (a) of FIG. 6.

As described earlier, according to the present embodiment, the lens holding plate 24 is made of a metal having high reflectivity. Therefore, the surface of the lens holding plate 24 serves as a reflector. As illustrated in (b) of FIG. 6, light emitted from an LED chip 23 and traveling in a lateral direction (in a direction parallel to the light emitting surface of the illumination apparatus 12) is reflected at a side face 24b of a hole 24a in the lens holding plate 24 (refer to the arrow B in (b) of FIG. 6). This makes it possible to reduce the amount of light leaking in the lateral direction from the LED chip 23, and thus possible to more efficiently irradiate a plant with the light from the LED chip. Note that, as an alternative to the above configuration, it is possible to employ a configuration in which a reflective sheet having a higher reflectivity is attached to the side face 24b (i.e., a surface 24b in contact with the lens 25) of the hole 24a in the lens holding plate 24.

Further, since the amount of light leaking in the lateral direction from the LED chips 23 is reduced like above, light emitted from each of the LED chips 23 is independent of those from the other LED chips 23. Therefore, by applying to an illumination apparatus of the present invention a light emitting system (e.g., a local dimming for use in a backlight of a liquid crystal display device) for locally controlling the amount of light emission, it is possible to selectively irradiate plants with respective different types of light (different amounts, different wavelengths, etc.).

(Specific Examples of Structure of Lens)

Next, the following description discusses, with reference to FIG. 7, other specific examples of a structure of a lens in the illumination apparatus 12 of the present embodiment. Note that the cooling plate 21 is not illustrated in (a) to (d) of FIG. 7. Further note that, although the lens holding plate 24 is extremely close to (substantially in contact with) the LED substrate 22 in the structure shown in FIG. 4, the lens holding plate 24 in the structure of FIG. 7 is provided at a certain distance from the LED substrate 22.

(a) of FIG. 7 shows an example of a configuration in which one lens 25a is provided with respect to one LED chip 23. The lens 25a illustrated in (a) of FIG. 7 is configured such that its bottom part (part in contact with the LED substrate 22) is larger in diameter than the other parts. In this configuration, lenses 25a are held by (i) covering the LED chips 23 on the LED substrate 22 with the respective lenses 25a and then (ii) placing the lens holding plate 24 on the lenses 25a so that the bottom parts of the respective lenses 25 are held down.

A lens 25b illustrated in (b) of FIG. 7 is a single member constituted by connecting a plurality of lens protrusions 26. Also in this configuration, almost in the same manner as in (a) of FIG. 7, the lens 25b is held by (i) covering the LED chips 23 on the LED substrate 22 with the respective protrusions 26 of the lens 25b and then (ii) placing the lens holding plate 24 on the lens 25b so that a connection between the protrusions 26 is held down.

On the other hand, a lens 25c illustrated in (c) of FIG. 7 is configured such that its bottom part (part to be inserted into the hole 24a) is smaller in diameter than the other parts. Each lens 25c is held independently by inserting the bottom part of that lens 25c into the hole 24a in the lens holding plate 24.

A lens 25d illustrated in (d) of FIG. 7, as is the case with the lens 25b illustrated in (b) of FIG. 7, is a single member constituted by connecting a plurality of lens protrusions 26. The lens 25d is fixed to the LED substrate 22 by (i) fitting bottom parts of the respective protrusions 26 of the lens 25d into respective holes 24a after placing the lens holding plate 24 on the LED substrate 22 and (ii) inserting a screw 27 so that the screw 27 passes through the lens 25d and the lens holding plate 24 (see (d) of FIG. 7).

According to any of the configurations above, each lens 25 on the LED substrate 22 is replaceable. Therefore, it is possible to attach different types of lenses 25 depending on the purposes for which the plant cultivation apparatus 10 is used.

Further, each of the configurations illustrated in the (b) and (d) of FIG. 7 can be (i) a configuration in which a single lens (optical member) formed by connecting a plurality of lens protrusions 26 is provided to the entire surface of a single LED substrate 22 or (ii) a configuration in which a plurality of lenses each formed by connecting a plurality of lens protrusions 26 are provided to a single LED substrate 22. According to the configuration in which a single lens is provided to a single LED substrate 22, it is possible to replace the lens on the entire substrate at a time.

On the other hand, according to the configuration in which a plurality of lenses are provided to a single LED substrate 22, it is preferable that the lens holding plate be separated so as to correspond to the lenses. This makes it possible to divide the light emitting surface of the illumination apparatus into a plurality of regions where respective different types of lenses are attached, and thus possible to individually replace the different types of lenses in the respective regions.

(a) and (b) of FIG. 8 illustrate an example in which lenses 25 are changed as the plant 31 grows. (a) of FIG. 8 illustrates an example of the illumination apparatus 12 when the plant 31 has just germinated in the plant cultivation apparatus 10. (b) of FIG. 8 illustrates an example of the illumination apparatus 12 when the plant 31 shown in (a) FIG. 8 has grown. Note that the cooling plate 21 is not illustrated in (a) to (c) of FIG. 8.

As is clear from a comparison between (a) and (b) of FIG. 8, the bottom of a lens 25e is deeper than that of a lens 25f. Light L1 emitted from an LED light source and passing through the deep lens 25e irradiates a relatively narrow area, and has a relatively high intensity. That is, high-intensity light is emitted downward from the LED chip 32. This makes it possible to efficiently irradiate the plant 31 which has just germinated and is thus small.

In contrast, the bottom of the lens 25f attached to the illumination apparatus 12, which is for grown plants, is shallower than that of the lens 25e. Light L2 emitted from an LED light source and passing through the shallow lens 25f irradiates a wider area than L2 does. This makes it possible to evenly irradiate the plant 31 which has grown large.

As has been described, according to the plant cultivation apparatus 10 of the present embodiment, it is possible to change the shapes of lenses 25 in accordance with the growth of a plant. Accordingly, the plant cultivation apparatus 10 makes it possible to create a light environment more suitable for the growth of the plant 31.

Note that, in a case of a plant where the surfaces of its leaves which increase number as the plant grows are desired to be evenly irradiated with light, it is preferable to (i) use the lens 25e for cultivating a just-geminated plant 31 and (ii) use the lens 25f for cultivating a grown plant 31, as described above. Note, however, that this does not imply any limitation on the present invention. That is, a lens for use in the plant cultivating apparatus of the present invention can be selected as appropriate depending on the type and/or growth state etc. of a plant so that a light environment most suitable for the plant is created.

Further, the plant cultivation apparatus 10 of the present embodiment can be configured such that a single lens 25g is provided to a plurality of LED chips 23 (see (c) of FIG. 8). With use of such a lens 25g, for example, it is possible to concentrate light L3 form three LED chips 23 to the vicinity of the center of the lens 25g (see (c) of FIG. 8). This makes it possible to intensively irradiate an area where the plant 31 is cultivated. Note however that, in a case of replacing the lens 25e illustrated in (a) of FIG. 8 with the lens 25g illustrated in (c) of FIG. 8, it is necessary to also change the lens holding plate 24 to another lens holding plate 24 corresponding to the shape of the lens 25g.

(Another Example of Configuration of Lens Holding Plate)

The lens holding plate 24 provided to the illumination apparatus 12 is made of a metal material. Note, however, that this does not imply any limitation on the present invention. For example, the same material can be used for the lens holding plate as is used for a light guide plate for use in a backlight for a liquid crystal display panel.

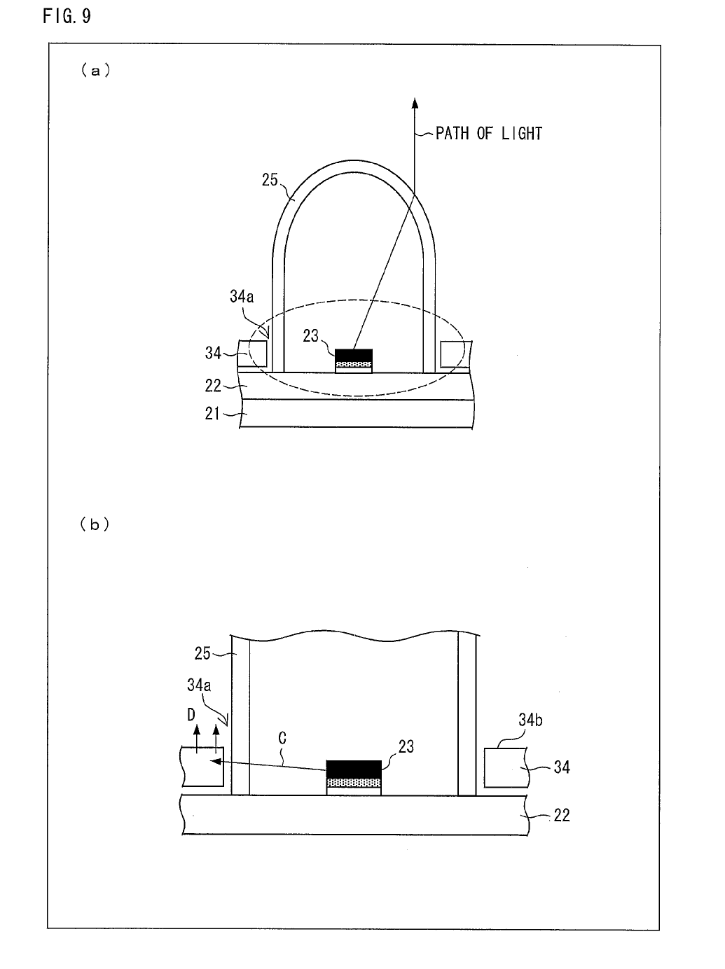

(a) of FIG. 9 is a cross-sectional view of a configuration of one of the lenses 25 of the illumination apparatus 12, in which configuration a lens holding plate 34 is constituted by a light guide plate. (b) of FIG. 9 is a more enlarged view of a part encircled by a dotted line of (a) of FIG. 9. Specific examples of a material for the lens holding plate 34 in this configuration include transparent resins such as (meth)acrylic resin, COP (cycloolefin polymer), COC (cycloolefin copolymer), and polycarbonate. These transparent resins are the same as those suitable for the foregoing lens 25. Note, however, that the material is not limited to these transparent resins, provided that the material allows light to be propagated and to pass therethrough.

In the case where the lens holding plate 34 is constituted by a light guide plate like above, as illustrated in (b) of FIG. 9, light emitted from an LED chip 23 and traveling in the lateral direction (in a direction parallel to the light emitting surface of the illumination apparatus 12) is propagated through the lens holding plate 34 (refer to the arrow C in (b) of FIG. 9), and is emitted through a surface 34b (light emitting surface) of the lens holding plate 34 (refer to the arrow D in (b) of FIG. 9). This makes it possible to emit light also from a region where no LED chip 23 is provided, and thus possible to reduce unevenness in brightness of the entire illumination apparatus 12. Further, even if the number of LED chips 23 is reduced, it is possible to emit relatively uniform light. This makes it possible to reduce cost.

Further, also in a case where the lens holding plate 34 is constituted by a light guide plate, the LED chip 23 is covered with the lens 25 and the lens holding plate 34. Therefore, the LED chip 23 is not exposed to a space where the plant 31 is placed. Accordingly, as is the case for the lens holding plate made of metal, the LED chip 23 is not damaged by condensation. This makes it possible to improve reliability of the LED chip 23 and increase the lifetime of the LED chip 23. Note however that, since a light guide plate has a lower thermal conductivity than metal, the lens holding plate constituted by the light guide plate is less effective for cooling than the lens holding plate 24 made of a metal material.

The lens holding plate can be made of a high thermal conductive resin. The high thermal conductive resin can be the one commercially available as “high thermal conductive resin”. Specific examples of the high thermal conductive resin include a high thermal conductive PPS (polyphenylene sulfide). Alternatively, a sheet obtained by blending a polymer such as acrylic polymer or silicon polymer with thermal conductive filler can be used as a lens holding plate made of a high thermal conductive resin.

Using such a high thermal conductive resin as a material for a lens holding plate enables the lens holding plate 24 to absorb heat generated from the LED chip and to efficiently dissipate the heat. This makes it possible to increase the effect of cooling the LED chip.

Note that, in this case, by attaching a reflective sheet having a higher reflectivity to a side face (i.e., the face in contact with the lens 25) of a hole 34a in the lens holding plate 34, it is possible to reduce light leaking in the lateral direction from the LED chip 23 and thus possible to irradiate a plant more efficiently with light from the LED chip.

The reflective sheet can be attached also to a surface of the lens holding plate 34 which surface is opposite to the light emitting surface 34b. This makes it possible to allow light to be more efficiently emitted toward the irradiation surface 34b side. Alternatively, it is possible to employ, instead of the configuration in which the reflective sheet is provided on the entire surface that is opposite to the light emitting surface 34b, a configuration in which a reflection part of a certain shape (for example, the shape of a dot) is partially printed on the surface.

### Embodiment 2

The following description discusses a second embodiment of the present invention. A plant cultivation apparatus 10 of the present embodiment is different in the configuration of an illumination apparatus from Embodiment 1. In view of this, the present embodiment describes only the differences between the present embodiment and Embodiment 1. Constituents not especially described here can have the same configurations as those of Embodiment 1.

The external appearance of the plant cultivation apparatus 10 in accordance with the present embodiment is illustrated in FIG. 2. The plant cultivation apparatus 10 includes an illumination apparatus 42 in accordance with the present embodiment.

(Configuration of Illumination Apparatus)

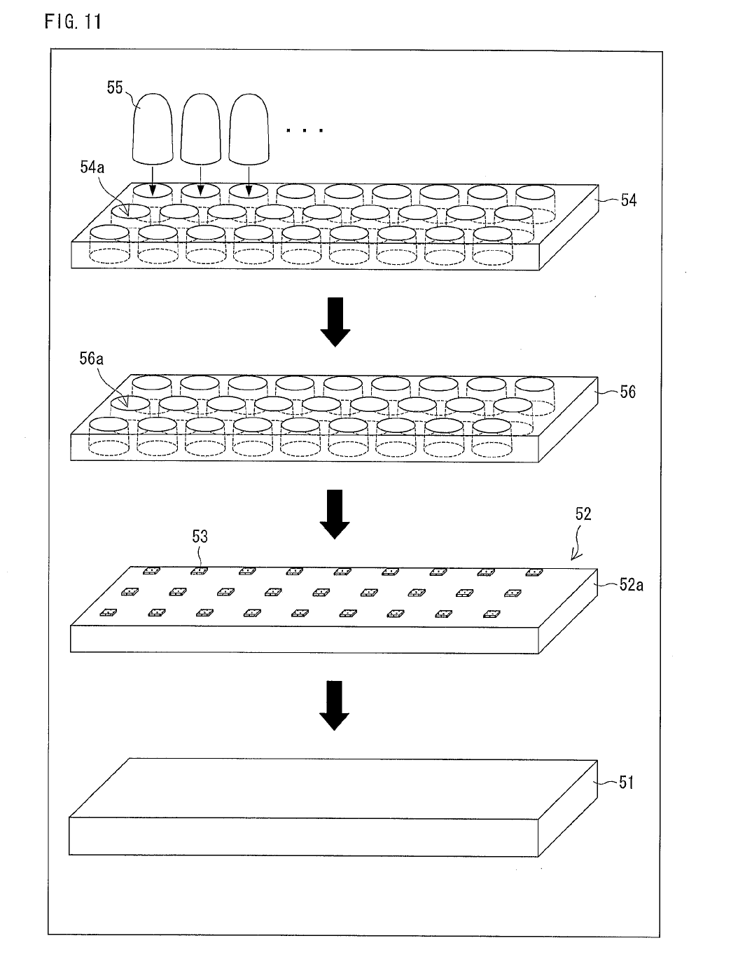

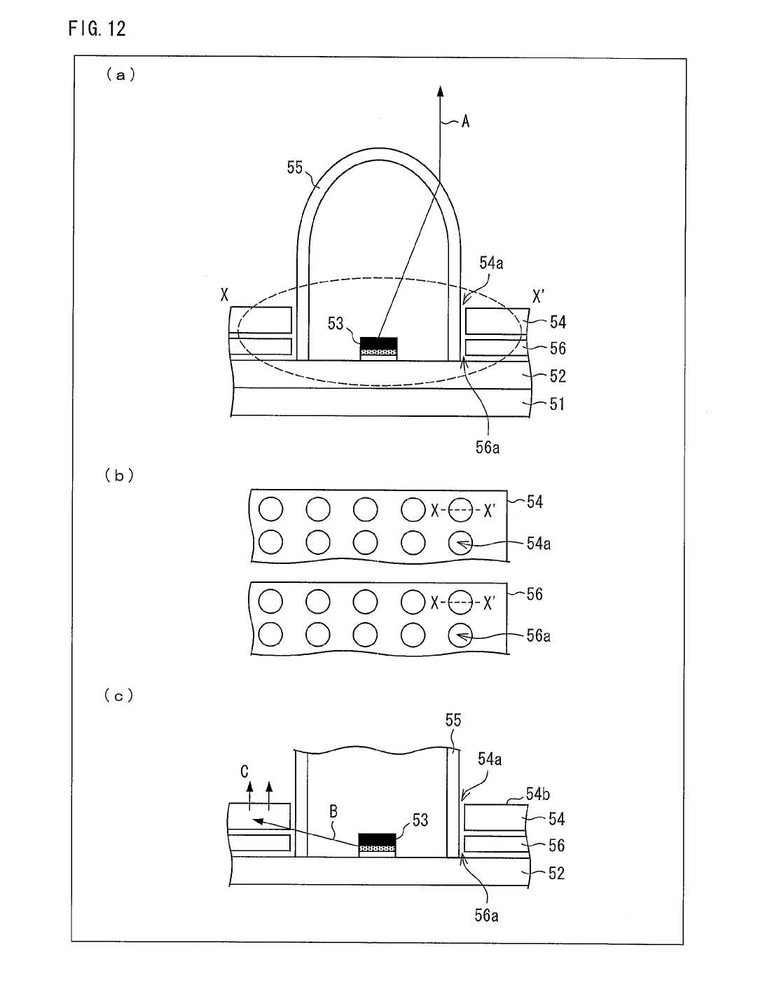

The following description discusses a specific configuration of the illumination apparatus 42 in accordance with the present embodiment. FIG. 10 is a perspective view of the illumination apparatus 42. In FIG. 10, the illumination apparatus 42, which is provided to the plant cultivation apparatus 10, is placed upside down. FIG. 11 illustrates disassembled components of the illumination apparatus 42. (a) of FIG. 12 is an enlarged view illustrating a lens of the illumination apparatus 42.

As illustrated in FIGS. 10 and 11, in the illumination apparatus 42, an LED substrate 52 (substrate), a thermal conductive sheet 56 and a lens holding plate 54 (a holding plate, an optical member) are stacked in this order on a cooling plate 51.

The cooling plate 51 is provided on the backside of the LED substrate 52, and is capable of absorbing heat generated from an LED chip 53 at a time of light irradiation.

The LED substrate 52 constituted by a substrate 52a (for example, an insulating substrate) on which a plurality of LED chips 53 (LED packages) are arranged. The LED chips 53 (light-emitting diodes) can be configured similarly to the LED chips 23 of Embodiment 1. Note that the LED chips can be LED chips that emit light of the same color or can be constituted by different kinds of LED chips that emit light of different wavelengths.

As illustrated in FIG. 11, the lens holding plate 54 has holes 54a which correspond to the LED chips 53 arranged on the LED substrate 52. With this configuration, the LED chips 53 are positioned in the respective holes 54a when the lens holding plate 54 is stacked on the LED substrate 52 (see (a) of FIG. 12). According to the present embodiment, the lens holding plate 54 is made of a resin having a light guiding property (light propagating property). That is, as is the case with the lens holding plate 34 illustrated in FIG. 9, the lens holding plate 54 is constituted by a light guide plate. More specifically, the lens holding plate 54 can be made of a transparent resin such as (meth)acrylic resin, COP (cycloolefin polymer), COC (cycloolefin copolymer) or polycarbonate.

The illumination apparatus 42 of the present embodiment further includes the thermal conductive sheet 56 provided between the LED substrate 52 and the lens holing plate 54, in addition to the foregoing plates and substrate. As illustrated in FIG. 11, the thermal conductive sheet 56 has holes 56a which correspond to the LED chips arranged on the LED substrate 52. With this configuration, the LED chips 53 lie in the respective holes 56a when the thermal conductive sheet 56 is stacked on the LED substrate 52 (see (a) of FIG. 12). Examples of a material for the thermal conductive sheet 56 include a thermal conductive olefin compound. Specific examples of the material for the thermal conductive sheet 56 include thermal conductive sheets produced by Furukawa Electric CO., Ltd. and DENKI KAGAKU KOGYO KABUSHI KAISHA. Note, however, that the material is not limited to them.

(b) of FIG. 12 illustrates part of configurations of the lens holding plate 54 and of the thermal conductive sheet 56, respectively, as viewed from above. (a) of FIG. 12 is a cross-sectional view taken along line X-X′ of (b) of FIG. 12.

As illustrated in (a) of FIG. 12, a lens 55 (a light path changing part, an optical member) for controlling the path of light emitted from the LED is fitted into each of the holes 54a in the lens holding plate 54 and each of the holes 56a in the thermal conductive sheet 56. That is, the lens 55 is provided on the LED substrate 52 so as to pass through the lens holding plate 54 and the thermal conductive sheet 56. The lens 55 is for controlling the intensity distribution of light emitted from an LED chip 53 in each direction (that is, the light distribution of the LED).

The light distribution of the LED can be controlled by changing as appropriate the shape of the lens 55 in view of Snell's law. Specifically, by changing the curvature of the curved surface of a protrusion of the lens 55 which has a convex shape, the path of light emitted from an LED chip 53 can be bent so that the path is perpendicular to the light emitting surface of the LED substrate 52, as indicated by the arrow A in (a) of FIG. 12.

The lens 55 can be made of the same material as that for the lens 25 of Embodiment 1.

(c) of FIG. 12 is a more enlarged cross-sectional view of part of the illumination apparatus illustrated in (a) of FIG. 12. The part of the illumination apparatus illustrated in (c) of FIG. 12 is a part encircled by a dotted line of (a) of FIG. 12. The part also corresponds to a cross section taken along line X-X′ of the lens holding plate 54 and the thermal conductive sheet 56 illustrated in (b) of FIG. 12.

As illustrated in (c) of FIG. 12, the illumination apparatus 42 of the present embodiment is configured such that the lens holding plate 54 made of a material having a light propagating property is provided on the outermost surface of a stack of a plurality of plates. Therefore, light emitted from the LED chip 53 and travels in the lateraling direction (direction parallel to the light emitting surface of the illumination apparatus 42) is propagated through the lens holding plate 54 (refer to the arrow B in (c) of FIG. 12), and is emitted through a surface 54b of the lens holding plate 54 (refer to the arrow C in (c) of FIG. 12). This makes it possible to emit light also from a region where no LED chip 53 is provided, and thus possible to reduce unevenness in brightness of the entire illumination apparatus 42. Further, even if the number of LED chips 53 is reduced, it is possible to emit relatively uniform light. This makes it possible to reduce cost.

Further, the illumination apparatus 42 of the present embodiment includes, in addition to the cooling plate 51 provided on the back surface of the LED substrate 52, the thermal conductive sheet 56 which is made of a high thermal conductive material and is provided between the LED substrate 52 and a plant 31 to be irradiated with light. With this configuration, the thermal conductive sheet 56 absorbs heat generated from the surface of the LED substrate 52, and the heat can be dissipated efficiently. This makes it possible to cool the LED chips more effectively than the configuration in which the LED chips are cooled only through the cooling plate 51.

Moreover, the illumination apparatus 42 of the present embodiment is configured such that (i) the lens 55 and the lens holding plate 54 are separately provided and (ii) the lens 55 is removably fitted in each of the holes 54a in the lens holding plate 54. This makes it possible to replace the lens with another lens that has a different shape depending on the purposes and to thereby control the direction in which light from the LED chips 53 travels and the area to be irradiated with the light.

Further, the illumination apparatus 42 of the present embodiment is configured such that the lens holding plate 54 and the lenses 55 are provided between the LED chips 53 and the plant 31. According to the present embodiment, since the LED chips 53 are covered with the lenses 55 and the lens holding plate 54 like above, the LED chips 53 are not exposed to a space where the plant 31 is placed. Therefore, even if condensation forms in the space where the plant 31 is placed, the condensation is on the surface of the lenses 55 (on the surface in contact with the space where the plant 31 is placed). That is, condensation does not form on the LED chips 53. Accordingly, the LED chips 53 are not damaged by condensation, and thus the reliability of the LED chips 53 can be improved and the lifetime of the LED chips 53 can be increased.

The present invention is not limited to the descriptions of the respective embodiments, but may be altered within the scope of the claims. An embodiment derived from a proper combination of technical means disclosed in different embodiments is encompassed in the technical scope of the invention.

In order to attain the above object, an illumination apparatus in accordance with the present invention is an illumination apparatus for irradiating a plant with light, including: light-emitting diodes serving as light sources; a substrate on which the light-emitting diodes are arranged; and an optical member provided between the substrate and the plant to be irradiated, the optical member being for changing the paths of light emitted from the light-emitting diodes, the optical member being removably attached to the illumination apparatus.

According to the illumination apparatus of the present invention, the optical member capable of changing the path of light from a light-emitting diode is removably attached to the apparatus. As used herein, the phrase “change the path of light” means making a change to light having been emitted from the light source so that the area to be irradiated with the light and/or the direction in which the light travels are changed. Further, the expression “change the path of light from the light-emitting diode” can be rephrased as “control the light distribution of the light-emitting diode”.

According to the above configuration, it is possible, by attaching optical members having different characteristics depending on the purposes, to change the area to be irradiated with light emitted from the light-emitting diode and the direction in which the light travels. Accordingly, the illumination apparatus of the present invention is capable of irradiating a plant with light efficiently depending on the type and/or growth state of the plant to be irradiated.

Further, according to a plant cultivation apparatus of the present invention, the optical member is provided between the plant and the substrate on which the light-emitting diodes are provided. This makes it possible to achieve a structure in which heat generated from the light-emitting diodes is difficult to reach the plant. Furthermore, in a case where the optical member is made of a high thermal conductive material, the optical member absorbs the heat generated from the light-emitting diodes and the surface of the substrate, and thus the heat can be efficiently dissipated. Accordingly, it is possible to cool the light-emitting diodes more effectively than a conventional configuration in which the light-emitting diodes are cooled only through the cooling plate provided on the back surface of the substrate.

Moreover, according to the above configuration, since the optical member is provided between the plant and the substrate on which the light-emitting diodes are provided, the substrate decreases in the area where it is exposed to the air. This makes it possible to make the substrate less cooled by air and make the light-emitting diodes less prone to condensation even if condensation forms because of a temperature difference between the space where the plant is placed and the light-emitting diodes. Accordingly, the light-emitting diodes are not damaged by condensation, so that the reliability of the light-emitting diodes can be improved and the lifetime of the light-emitting diodes can be increased.

The illumination apparatus of the present invention can be configured such that: the optical member includes a light path changing part and a holding plate for holding the light path changing part; and the holding plate has a hole corresponding to one of or two or more of the light-emitting diodes provided on the substrate, and the light path changing part is attached in the hole.

According to the above configuration, it is possible to replace only the light path changing part with a different type of a light path changing part while leaving the holding plate attached to the apparatus. This makes it possible to easily control, depending on the type and growth state etc. of the plant, light emitted from the light-emitting diodes so that the light has a desired distribution.

Further, according to the above configuration, since the light path changing part such as the lens is fitted in the hole in the holding plate, the light-emitting diodes provided on the substrate are isolated from the space where the plant is placed. Therefore, even if condensation forms because of a temperature difference between the space where the plant is placed and the light-emitting diodes, the condensation is on the surface of the holding plate and the surface of the light path changing part (i.e., on the surface in contact with the space where the plant is placed). That is, condensation does not form on the light-emitting diodes. Accordingly, the light-emitting diodes are not damaged by condensation, so that the reliability of the light-emitting diodes can be improved and the lifetime of the light-emitting diodes can be increased.

The illumination apparatus of the present invention can be configured such that one light-emitting diode or two or more light-emitting diodes serve(s) as one unit, and the light path changing part is provided in such a way as to correspond to the one unit.

According to the above configuration, light path changing parts can be replaced in units of one or two or more. This makes it possible to cause the paths of light emitted from light-emitting diodes to differ among positions where the light-emitting diodes are provided. It is possible to control, in a single illumination apparatus, the properties (e.g., the area to be irradiated with light and the direction in which the light travels) of light region by region depending on the condition of the plant to be irradiated.

The illumination apparatus of the present invention can be configured that the optical member is constituted by a plurality of members, and the plurality of members are independently removably attached to the illumination apparatus.

According to the above configuration, it is possible to divide the light emitting surface of the illumination apparatus into a plurality of regions in which respective different types of components are attached, and thus possible to individually replace the optical members in the respective regions.

The illumination apparatus of the present invention can be configured such that the holding plate is made of a metal material.

According to the above configuration, since the holding plate provided between the plant and the substrate on which the light-emitting diodes are provided is made of a metal material having high thermal conductivity, the thermal conductive sheet absorbs heat generated from the light-emitting diodes and can dissipate the heat efficiently. This makes it possible to more effectively cool the light-emitting diodes.

The illumination apparatus of the present invention can be configured such that the holding plate is made of a resin having a light guiding property.

According to the configuration, it is possible to allow light emitted from the light-emitting diodes to be propagated through the resin having a light guiding property and be efficiently emitted to the side on which the plant is placed. This makes it possible to emit relatively strong light also from a region of the substrate in which region no light-emitting diode is provided. Accordingly, it possible to realize an illumination apparatus that is capable of emitting uniform light or irradiating a large area even if the number of light-emitting diodes is reduced.

The illumination apparatus of the present invention can be configured such that the holding plate further includes a reflective sheet attached to the resin having a light guiding property.

According to the configuration, it is possible to allow light emitted from the light-emitting diodes to be propagated through the light-guiding resin and be emitted, due to a reflex action of the reflective sheet, more efficiently to the side on which the plant is placed. Accordingly, it is possible to realize an illumination apparatus that is capable of emitting uniform light or irradiating a large area even if the number of light-emitting diodes is reduced.

The illumination apparatus of the present invention can further include a thermal conductive sheet provided between the substrate and the holding plate.

According to the configuration, the thermal conductive sheet can absorb heat generated from the light-emitting diodes and dissipate the heat efficiently. This makes it possible to more effectively cool the light-emitting diodes.

The illumination apparatus of the present invention can be configured such that the holding plate is made of a high thermal conductive resin.

According to the above configuration, the holding plate made of a high thermal conductive resin can absorb heat generated from the light-emitting diodes and dissipate the heat efficiently. This makes it possible to more effectively cool the light-emitting diodes.

The illumination apparatus of the present invention can be configured such that the light path changing part is a lens.

According to the above configuration, it is possible, by using lenses that have different shapes, to easily change the properties (e.g., the area to be irradiated with light and the direction in which the light travels) of light emitted from a light-emitting diode.

The illumination apparatus of the present invention can further include a cooling plate provided on a back surface of the substrate.

According to the above configuration, since the cooling plate is provided, it is possible to more efficiently suppress an increase in temperature of the substrate, which increase is caused by heat generated from the light-emitting diodes.

A plant cultivation apparatus in accordance with the present invention includes any of the above illumination apparatuses.

Accordingly, the plant cultivation apparatus of the present invention is capable of changing, depending on the purposes, the area to be irradiated with light emitted from a light-emitting diode and the direction in which the light travels. Further, according to the plant cultivation apparatus of the present invention, since the optical member is provided between the plant and the substrate on which the light-emitting diodes are provided, it is possible to achieve a structure in which heat generated from the light-emitting diodes is difficult to reach the plant.

Further, according to the plant cultivation apparatus of the present invention, since the optical member is provided between the plant and the substrate on which the light-emitting diodes are provided, it is possible to make the light-emitting diodes less prone to condensation even if condensation forms because of a temperature difference between the space where the plant is placed and the light-emitting diodes. As such, the light-emitting diodes are not damaged by condensation, so that the reliability of the light-emitting diodes can be improved and the lifetime of the light-emitting diodes can be increased.

The embodiments discussed in the foregoing description of embodiments and concrete examples serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to artificial light sources for plant factories and plant cultivation apparatuses for cultivating plants such as vegetables indoors.

### REFERENCE SIGNS LIST

10 Plant cultivation apparatus
11 Case
12 Illumination apparatus
21 Cooling plate
22 LED substrate (substrate)
23 LED chip (light-emitting diode)
24 Lens holding plate (holding plate, optical member)
24a Hole (in lens holding plate)
25 Lens (light path changing part, optical member)
25a to 25g Lens (light path changing part, optical member)
34 Lens holding plate (holding plate, optical member)
42 Illumination apparatus
51 Cooling plate
52 LED substrate (substrate)
53 LED chip (light-emitting diode)
54 Lens holding plate (holding plate, optical member)
54a Hole (in lens holding plate)
55 Lens (light path changing part, optical member)
56 Thermal conductive sheet

1. An illumination apparatus for irradiating a plant with light, comprising:
light-emitting diodes serving as light sources;
a substrate on which the light-emitting diodes are arranged; and
an optical member provided between the substrate and the plant to be irradiated, the optical member being for changing the paths of light emitted from the light-emitting diodes,
the optical member being removably attached to the illumination apparatus.

2. The illumination apparatus as set forth in claim 1, wherein:
the optical member includes a light path changing part and a holding plate for holding the light path changing part; and
the holding plate has a hole corresponding to one of or two or more of the light-emitting diodes provided on the substrate, and the light path changing part is attached in the hole.

3. The illumination apparatus as set forth in claim 2, wherein one light-emitting diode or two or more light-emitting diodes serve(s) as one unit, and the light path changing part is provided in such a way as to correspond to the one unit.

4. The illumination apparatus as set forth in claim 1, wherein the optical member is constituted by a plurality of members, and the plurality of members are independently removably attached to the illumination apparatus.

5. The illumination apparatus as set forth in claim 2, wherein the holding plate is made of a metal material.

6. The illumination apparatus as set forth in claim 2, wherein the holding plate is made of a resin having a light guiding property.

7. The illumination apparatus as set forth in claim 6, wherein the holding plate further includes a reflective sheet attached to the resin having a light guiding property.

8. The illumination apparatus as set forth in claim 6, further comprising a thermal conductive sheet provided between the substrate and the holding plate.

9. The illumination apparatus as set forth in claim 2, wherein the holding plate is made of a high thermal conductive resin.

10. The illumination apparatus as set forth in claim 2, wherein the light path changing part is a lens.

11. The illumination apparatus as set forth in claim 1, further comprising a cooling plate provided on a back surface of the substrate.

12. A plant cultivation apparatus comprising an illumination apparatus as set forth in claim 1.
